(19) United States
(12) Patent Application Publication
(10) Pub. No.: US 2004/0067477 A1
(43) Pub. Date: Apr. 8, 2004

(54) Model of dental caries

(76) Inventor: Thomas D. Marshall, San Antonio, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/617,484

(22) Filed: Jul. 11, 2003

Related U.S. Application Data
(60) Provisional application No. 60/395,432, filed on Jul. 11, 2002.

(51) Int. Cl. G09B 23/28

(52) U.S. Cl. 434/263

(57) ABSTRACT

A model of dental caries may include simulated decay material in a cavity in an artificial tooth. The artificial tooth may be made of resin. The cavity may include an opening that extends from a simulated enamel surface to, e.g., at least the dentinoenamel junction of the tooth. The model may include at least one groove that extends from the opening (e.g., along the dentinoenamel junction). The cavity may contain simulated decay material in a groove and/or the opening. The simulated decay material is a homogenous substance that may include a curable resin, a porous substance, and/or coloring. The simulated decay material may be detectable with caries detecting stain. An etching solution and/or a curable bonding substance may be applied to the cavity before the simulated decay material is applied. The simulated decay material may simulate dental caries in color, texture, and/or tenacity.

### PRIORITY CLAIM

This application claims priority to U.S. Provisional Application No. 60/395,432 entitled “MODEL OF DENTAL CARIES” filed Jul. 11, 2002. The above-referenced provisional application is hereby incorporated by reference as if fully set forth herein.

### BACKGROUND

1. Field of Invention

The present invention generally relates to a model of dental caries. Embodiments of the invention relate to a model of dental caries that simulates dental decay in color, texture, and/or tenacity.

2. Description of Related Art

Traditionally, pre-clinical dental students learn to treat various classifications of decayed teeth by working on pristine resin teeth (teeth without defects) arranged in simulated upper and lower resin jaws. In some cases, students may work with resin teeth with defects. These defects may include various defects caused by human dental decay (caries). Some resin teeth have defects but contain no simulated decay material. Other resin teeth for pre-clinical use contain simulated decay material. Currently, simulated carious resin teeth are produced by cutting away the outer layer of a resin crown, cutting defects into the prepared tooth, inserting simulated carious material into the defects, and then covering the prepared tooth with a resin crown. No opening is provided into the dental cavity. Furthermore, the simulated carious material may be a heterogeneous substance with unrealistic color, texture, and/or tenacity.

### SUMMARY

A model of dental caries may include simulated decay material in a cavity in an artificial tooth. In an embodiment, the artificial tooth may be made of resin, such as melamine resin. The cavity may include an opening that extends from an exterior surface of the tooth to an interior of the tooth. In some embodiments, an opening may extend at least to the dentinoenamel junction of the tooth. The opening may include at least one groove that extends from the opening along at least a portion of the dentinoenamel junction. A groove may mimic progression of decay along the dentinoenamel junction. In an embodiment, one or more grooves are formed with a wheel bur. The cavity may be cleaned with an etching solution. The etching solution may be a liquid or a gel. In an embodiment, the etching solution may contain acid, such as phosphoric acid and/or orthophosphoric acid. The etching solution may be rinsed with water and the tooth may be dried. A bonding substance, such as a liquid resin, may be applied to the walls of the cavity. In certain embodiments, the bonding substance may be chemically, light, and/or heat cured.

In various embodiments, a cavity may contain simulated decay material. The simulated decay material may be in an opening and/or in at least one groove in the tooth. In an embodiment, the simulated decay material is a homogenous substance. The simulated decay material may consist of a curable resin and a porous substance. The curable resin may be chemically cured or cured with light and/or heat. In an embodiment, the porous substance may include pumice. In an embodiment, the simulated decay material may include coloring, such as food coloring. The simulated decay material may simulate human dental decay in color, texture, and/or tenacity. The simulated decay material may be detectable with caries detecting stain. In some embodiments, the simulated decay material may be radio-opaque. In other embodiments, the simulated decay material may mimic the radiolucence of naturally occurring decay material.

### BRIEF DESCRIPTION OF THE DRAWINGS

Advantages of the present invention will become apparent to those skilled in the art with the benefit of the following detailed description and upon reference to the accompanying drawings in which:

FIG. 1 depicts an opening in a resin tooth.

FIG. 2 depicts a wheel bur positioned to cut a groove in a resin tooth.

FIG. 3 depicts a schematic of a sagittal section of a cavity with an opening and a groove cut along a dentinoenamel junction of a resin tooth.

FIG. 4 depicts simulated decay material in a groove along the dentinoenamel junction.

FIG. 5 depicts a schematic of a sagittal section of simulated decay material in a groove cut along a dentinoenamel junction of a resin tooth.

FIG. 6 depicts simulated decay on a side of an opening in a resin tooth.

FIG. 7 depicts simulated decay material in an opening in a resin tooth.

FIG. 8 depicts a schematic of a sagittal section of simulated decay material in a cavity in a resin tooth.

FIG. 9 depicts simulated occlusal decay.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

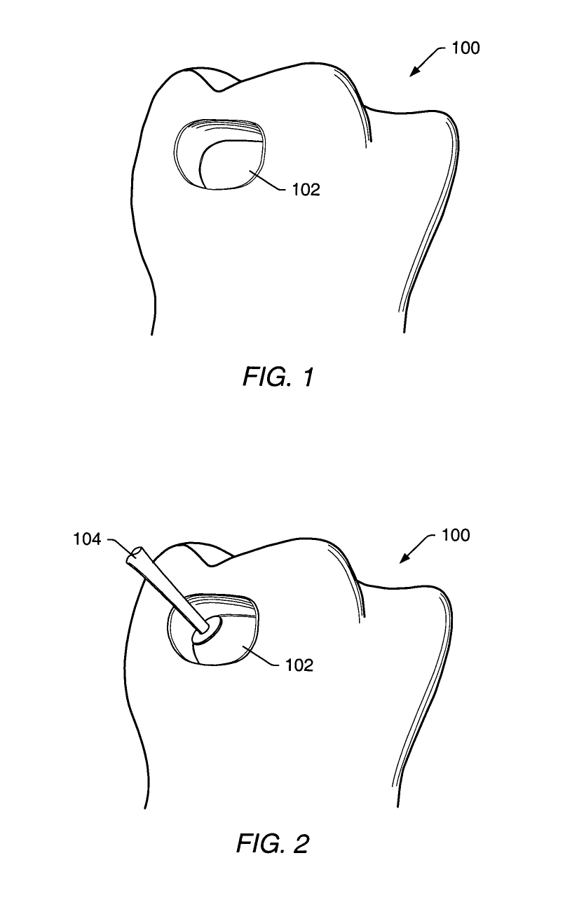

FIG. 1 depicts artificial tooth 100 with opening 102. In an embodiment, tooth 100 may be made of resin, such as melamine resin, or any other material approved by the American Dental Association for use as artificial teeth for use in dental education and for use in state and/or regional board examinations. Opening 102 may extend from the enamel or exterior surface to an interior of the tooth. In some embodiments, opening 102 may extend from the enamel or exterior surface to at least an artificial dentinoenamel junction. In certain embodiments, opening 102 extends beyond the artificial dentinoenamel junction into artificial dentin.

In FIG. 2, wheel bur 104 is shown inserted into opening 102 of tooth 100. In an embodiment, wheel bur 104 may be used to cut one or more grooves extending from the opening along the dentinoenamel junction. In other embodiments, other instruments may be used to cut one or more grooves along the dentinoenamel junction. As used herein, a “groove” is an opening including, but not limited to, a valley, a notch, etc. In some embodiments, a groove may be formed around a full circumference of the opening. In other embodiments, one or more grooves may be formed around a portion or portions of the circumference of the opening. The grooves are cut to simulate progression of human dental decay as the decay spreads from the opening in the enamel along the dentinoenamel junction. In certain embodiments, grooves may be cut in various locations in the artificial tooth. One or more grooves may be completely or partially filled with simulated decay material to form various embodiments of a tooth with caries. A groove with simulated decay material may provide a representative model of caries along the dentinoenamel junction of a tooth.

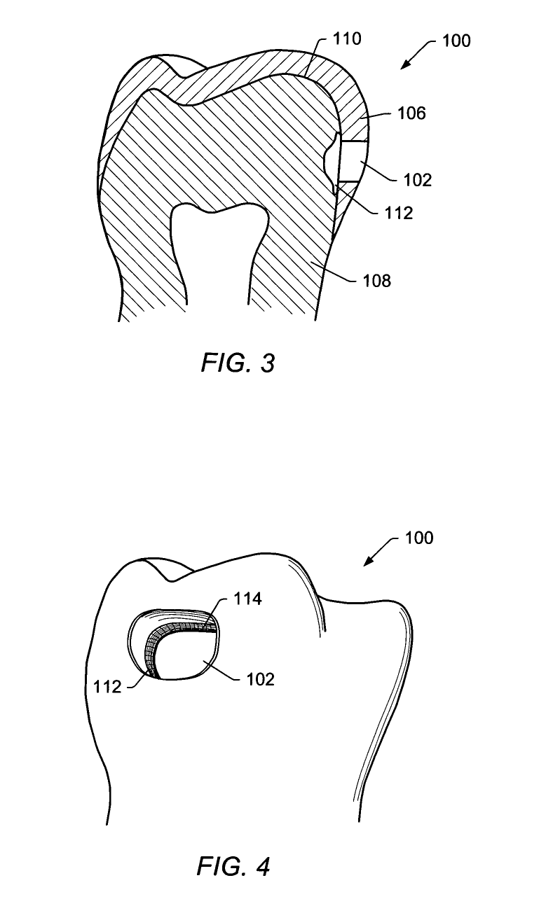

A schematic of a sagittal section of tooth 100 is shown in FIG. 3. “Sagittal section” is used herein to refer to a longitudinal cross section. Artificial enamel layer 106 and artificial dentin 108 form an interface at dentinoenamel junction 110. Groove 112 is shown extending from opening 102 along dentionenamel junction 110. In an embodiment, a cavity in tooth 100 may include opening 102. Opening 102 may include one or more grooves 112. Grooves 112 simulate the spread of dental decay along dentionenamel junction 110. In the embodiment of FIG. 3, opening 102 extends beyond dentinoenamel juction 110 into dentin 108. FIG. 4 depicts simulated decay material 114 substantially in groove 112 extending from opening 102 along the dentinoenamel junction of tooth 100.

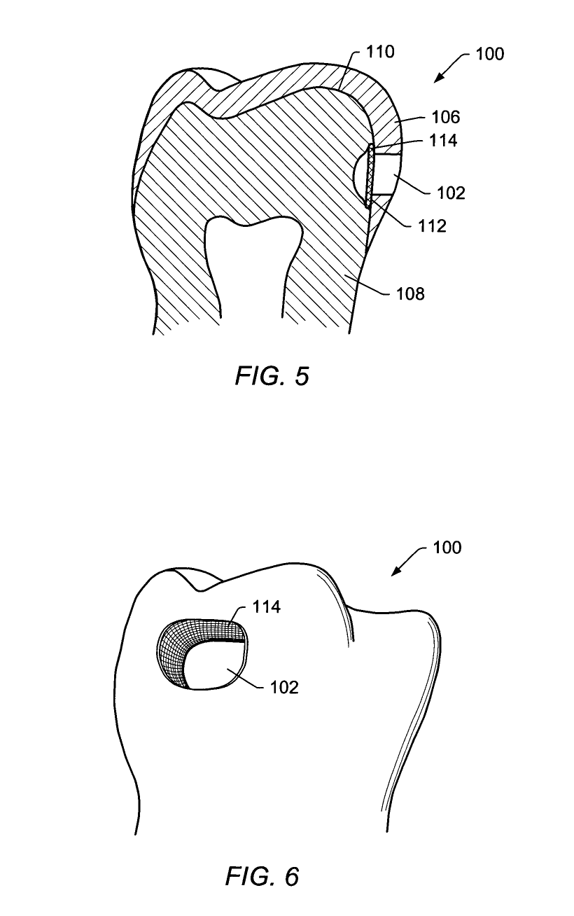

FIG. 5 depicts a schematic of a sagittal section of tooth 100 with a cavity including opening 102 and groove 112. In the embodiment of FIG. 5, opening 102 extends through artificial enamel 106, beyond dentinoenamel junction 110, and into dentin 108. At least a portion of groove 112 may contain simulated decay material 114.

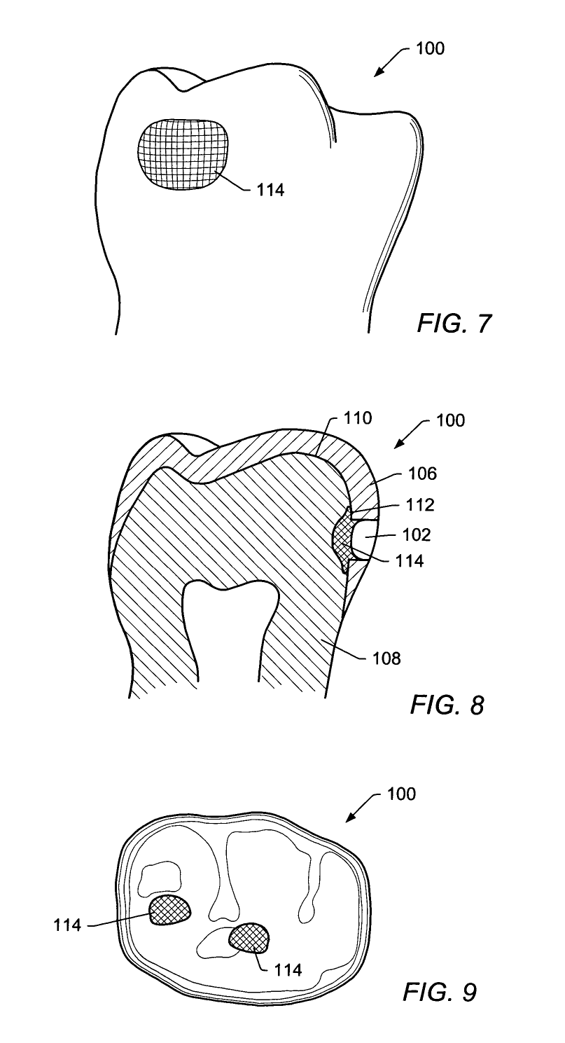

FIG. 6 depicts an embodiment of simulated decay material 114 in opening 102 of tooth 100. In the embodiment of FIG. 6, simulated decay material 114 is located substantially along a side of opening 102 in tooth 100. FIG. 7 depicts another embodiment of simulated decay material 114 in an opening in tooth 100. In the embodiment of FIG. 7, simulated decay material 114 extends beyond the dentinoenamel junction and substantially fills the opening in tooth 100. FIG. 8 depicts a schematic of a sagittal section of simulated decay material 114 in opening 102 in tooth 100. In the embodiment shown in FIG. 8, simulated decay material 114 fills part of opening 102 in tooth 100. In this embodiment, at least part of groove 112 along dentinoenamel junction 110 between artificial enamel 106 and dentin 108 contains simulated decay material 114. FIG. 9 depicts an occlusal view of tooth 100 with simulated occlusal decay shown by simulated decay material 114.

FIGS. 4-9 show various embodiments of defects and simulated decay in artificial teeth. Other embodiments may include various types and sizes of defects, as well as various extents of decay. In some embodiments, decay in a model tooth may be limited to a small portion of an opening in the tooth. In other embodiments, a model tooth may be made to exhibit extensive decay in a pulpal direction and/or along grooves in the dentinoenamel junction. Openings may be formed on any exterior surface of an artificial tooth. The composition of simulated decay material may be chosen to simulate the color, texture, and/or tenacity of dental caries at various stages of decay.

In an embodiment, an artificial tooth with simulated decay may be formed from a pristine resin tooth. A defect of a desired character may be formed in the tooth with an appropriate cutting or drilling instrument. A groove may be formed in the tooth along the dentinoenamel junction, as shown in FIG. 2. An etching solution, such as a gel or a liquid, may be applied to surface defined by a cavity, including a surface defined by an opening and/or a surface defined by one or more grooves. The etching solution may contain an acid. In certain embodiments, the etching solution may include phosphoric acid and/or orthophosphoric acid. Specifically, the etching solution may be a solution of orthophosphoric acid (e.g., a solution containing 20-50% acid in water or a solution containing 37% acid in water). The etching solution may be applied to a surface defined by the cavity with a brush or similar applicator with a felt tip or sponge tip. The etching solution may be allowed to remain on the resin tooth for a period of at least 5 seconds to 60 seconds or longer, such as 10-30 seconds or 15-20 seconds, depending on the composition and concentration of the etching solution. The etching solution may be rinsed from the tooth (with, e.g., water). The tooth may be dried.

A bonding substance, such as a liquid resin, including unfilled or lightly filled resins, may be applied to a surface defined by the cavity. The bonding substance may wet the tooth. In an embodiment, the bonding substance may adhere to the resin tooth and bond to synthetic resin. In various embodiments, the bonding substance may be a commercial dentin bonding agent or a mixture of methyl methacrylate and methylene chloride. In other embodiments, the bonding substance may be any substance capable of wetting and adhering to resin teeth. The bonding substance may be applied with a brush or similar applicator with a felt tip or sponge tip. Preparation of the tooth for application of simulated decay material may include curing the bonding substance with heat or light (e.g., visible, ultraviolet, or infrared light). In an embodiment, the bonding substance may be cured with visible light with a wavelength of about 500 nm and an output of about 300 milliwatts/square centimeter for about 10 seconds to about 30 seconds, or about 20 seconds. A light source such as the ESPE-Highlight manufactured by 3M (St. Paul, Minn.) or other similar light or lights may be used.

Simulated decay material may be applied to a cavity, including the opening and/or one or more grooves. Some naturally occurring dental caries may have a soft outer layer and increasingly harder inner layers. Other naturally occurring dental caries may have a substantially uniform hardness. Applying simulated decay material of a uniform composition may result in simulated dental caries of uniform hardness. Layering of simulated decay material of various compositions may result in simulated dental caries with layers of varying hardness. In some embodiments, an inner layer of simulated decay material may have a greater hardness than an outer layer of simulated decay material. In other embodiments, an outer layer of simulated decay material may have a greater hardness than an inner layer of simulated decay material.

Simulated decay material may include a resin. In an embodiment, the resin is non-hardening. The resin may be any material approved for use by the American Dental Association of suitable texture (i.e., consistency) to simulate human dental caries. The resin may be heat cured and/or chemically cured. In an embodiment, the resin may be cured with light. The resin may be radio-opaque or radiotranslucent. Tempit® L/C, manufactured by Centrix Incorporated (Shelton, Conn.), a resin which tends to stay pliable after curing, may be used in simulated decay material. Properties of the resin may allow the simulated decay material to be removed from a tooth with an excavator or other dental instrument. In an embodiment, caries detecting stain may be used to check for complete removal of simulated decay material in a pre-clinical setting.

Simulated decay material may include a porous substance. The porous substance may include pumice or similar material. The porous substance may be approved for use by the American Dental Association. Nupro® T Prophylaxis Paste manufactured by Dentsply Preventive Care (York, Pa.) may be used as the porous substance. In some embodiments, simulated decay material may contain substantially equal portions of resin and porous substance. In other embodiments, depending on the desired texture of the simulated decay material, the ratio of resin to porous substance may range from about 1:5 parts by volume resin to porous substance to about 5:1 parts by volume resin to porous substance. A 1:1 volume ratio of resin to porous substance may result in simulated decay material with an intermediate texture (e.g., intermediate hardness). A greater volume of resin than porous substance may result in simulated decay material with a harder texture. A greater volume of porous substance than resin may result in simulated decay material with a softer texture. In some embodiments, a homogeneous simulated decay material may be used in to form artificial caries of uniform hardness. In other embodiments, homogeneous simulated decay materials of various compositions may be layered in cavities of artificial teeth to create simulated caries of varying hardness.

Simulated decay material may be detected by a caries detecting stain, such as Cari-D-Tect, manufactured by Gresco Products, Inc. (Stafford, Tex.). In some embodiments, simulated decay material may be radio-opaque. In other embodiments, simulated decay material may be radiotranslucent. Upon X-ray, radiotranslucent simulated decay material may appear substantially the same as naturally occurring decay material.

In an embodiment, coloring may be added to the resin/porous substance mixture to simulate the color of human dental caries. The coloring may be food coloring or any coloring approved for use by the American Dental Association or the Federal Drug Administration. Coloring may be added to achieve a desired coloring of simulated decay material. In various embodiments, the desired color may range from dentin color to tan, to shades of brown, gray, and/or black.

In some embodiments, the simulated decay material may be chemically cured or heat cured. In certain embodiments, the simulated decay material may be cured with light, such as visible light with a wavelength of about 500 nm, to achieve the desired texture and tenacity (i.e., degree of bonding to the tooth). In an embodiment, the simulated decay material may be cured with visible light with a wavelength of about 500 nm and an output of about 300 milliwatts/square centimeter for about 10 seconds to about 70 seconds, about 20 seconds to about 60 seconds, about 30 seconds to about 50 seconds, or about 40 seconds. Simulated decay material of a darker color may require a longer curing time that simulated decay material of a lighter color.

Simulated decay material in a cavity of an artificial tooth may be cured with one or more applications of heat and/or light. In some embodiments, simulated dental caries may be formed by curing simulated decay material of uniform hardness with one application of heat and/or light. In certain embodiments, simulated dental caries may be formed by successively curing layers of simulated decay material. Successively curing layers of simulated decay material of uniform hardness may result in simulated dental caries of uniform hardness. Successively curing layers of simulated decay material of varying hardness may result in simulated dental caries with layers of varying hardness.

The model of dental caries described in the above embodiments is a realistic representation of human dental decay. Advantages of certain embodiments of this model include a substantially homogeneous simulated decay material that mimics human carious dentin in color, texture, and tenacity. Another advantage of certain embodiments is the sensitivity of the simulated decay material to caries detecting stain. Another advantage of the model of dental caries is the presence of one or more grooves along the dentinoenamel junction, replicating the progression of dental caries in the human condition. Another advantage of certain embodiments of the model of dental caries described above is the low cost and ready availability of materials needed to incorporate simulated decay into artificial teeth.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A model of dental caries, comprising:
an artificial tooth, wherein the artificial tooth comprises a cavity, and wherein the cavity comprises:
an opening that extends from an exterior surface of the artificial tooth to at least a simulated dentinoenamel junction of the artificial tooth; and
wherein the opening extends along at least a portion of the simulated dentinoenamel junction; and
simulated decay material in the cavity.

2. The model of dental caries of claim 1, wherein the opening contains simulated decay material.

3. The model of dental caries of claim 1, wherein the opening comprises one or more grooves along the simulated dentinoenamel junction.

4. The model of dental caries of claim 1, wherein the opening comprises one or more grooves, and wherein at least one of the grooves contains simulated decay material.

5. The model of dental caries of claim 1, wherein the artificial tooth comprises resin.

6. The model of dental caries of claim 1, wherein the artificial tooth comprises melamine resin.

7. The model of dental caries of claim 1, wherein a surface defined by the cavity is configured to bond to the simulated decay material.

8. The model of dental caries of claim 1, wherein a surface defined by the cavity is textured.

9. The model of dental caries of claim 1, wherein a surface defined by the cavity is textured with an etching solution.

10. The model of dental caries of claim 1, wherein a surface defined by the cavity is textured with an etching solution, and wherein the etching solution comprises an acid.

11. The model of dental caries of claim 1, wherein the simulated decay material comprises a resin material.

12. The model of dental caries of claim 1, wherein the simulated decay material comprises a porous substance.

13. The model of dental caries of claim 1, wherein the simulated decay material comprises a porous substance, and wherein the porous substance comprises pumice.

14. The model of dental caries of claim 1, wherein the simulated decay material comprises coloring.

15. The model of dental caries of claim 1, wherein the simulated decay material comprises food coloring.

16. The model of dental caries of claim 1, wherein the simulated decay material is homogeneous.

17. The model of dental caries of claim 1, wherein the simulated decay material is curable.

18. The model of dental caries of claim 1, wherein the simulated decay material is light curable.

19. The model of dental caries of claim 1, wherein the simulated decay material is curable with visible light.

20. The model of dental caries of claim 1, wherein the simulated decay material is detectable by caries detecting stain.

21. The model of dental caries of claim 1, wherein the simulated decay material is radiolucent.

22. The model of dental caries of claim 1, wherein the simulated decay material is radio-opaque.

23. The model of dental caries of claim 1, wherein the simulated decay material is of uniform hardness.

24. The model of dental caries of claim 1, wherein an outer layer of simulated decay material is softer than an inner layer of simulated decay material.

25. The model of dental caries of claim 1, wherein an inner layer of simulated decay material has a greater hardness than an outer layer of simulated decay material.

26. A model of dental caries, comprising:
an artificial tooth, wherein the artificial tooth comprises a cavity, and wherein the cavity comprises:
an opening that extends from an exterior surface of the artificial tooth to at least a simulated dentinoenamel junction of the artificial tooth; and
one or more grooves extending from the opening; and
simulated decay material in the cavity.

27. The model of dental caries of claim 26, wherein the opening contains simulated decay material.

28. The model of dental caries of claim 26, wherein at least one of the grooves extends along at least a portion of the simulated dentinoenamel junction.

29. The model of dental caries of claim 26, wherein at least one of the grooves extends along at least a portion of the simulated dentinoenamel junction, and wherein at least one of the grooves contains simulated decay material.

30. The model of dental caries of claim 26, wherein the artificial tooth comprises resin.

31. The model of dental caries of claim 26, wherein the simulated decay material is radiolucent.

32. The model of dental caries of claim 26, wherein the simulated decay material is radio-opaque.

33. The model of dental caries of claim 26, wherein the simulated decay material is of uniform hardness.

34. The model of dental caries of claim 26, wherein an outer layer of simulated decay material is softer than an inner layer of simulated decay material.

35. The model of dental caries of claim 26, wherein an inner layer of simulated decay material has a greater hardness than an outer layer of simulated decay material.

36. A method comprising:
forming a cavity in an artificial tooth, wherein the cavity comprises:
an opening extending from an exterior surface of the artificial tooth to at least a simulated dentinoenamel junction of the artificial tooth; and
wherein the opening extends along at least a portion of the simulated dentinoenamel junction; and
applying simulated decay material to the cavity.

37. The method of claim 36, further comprising forming one or more grooves in the opening.

38. The method of claim 36, further comprising forming one or more grooves in the opening, wherein at least one of the grooves is formed with a wheel bur.

39. The method of claim 36, wherein applying the simulated decay material to the cavity comprises comprising applying the simulated decay material to the opening.

40. The method of claim 36, further comprising forming one or more grooves in the opening and applying simulated decay material to at least one of the grooves.

41. The method of claim 36, wherein the artificial tooth comprises resin.

42. The method of claim 36, wherein the artificial tooth comprises melamine resin.

43. The method of claim 36, further comprising applying an etching solution to a surface defined by the cavity, and wherein the etching solution comprises an acid.

44. The method of claim 36, further comprising applying an etching solution to a surface defined by the cavity, wherein the etching solution comprises an acid, and further comprising rinsing the etching solution from the cavity.

45. The method of claim 36, further comprising applying a bonding substance to a surface defined by the cavity.

46. The method of claim 36, further comprising applying a bonding substance to a surface defined by the cavity and curing the bonding substance.

47. The method of claim 36, further comprising applying a bonding substance to a surface defined by the cavity and curing the bonding substance with light.

48. The method of claim 36, further comprising applying a bonding substance to a surface defined by the cavity and curing the bonding substance with visible light.

49. The method of claim 36, further comprising applying a bonding substance to a surface defined by the cavity, and wherein the bonding substance comprises a liquid resin.

50. The method of claim 36, wherein the simulated decay material comprises a resin material.

51. The method of claim 36, wherein the simulated decay material comprises a porous substance.

52. The method of claim 36, wherein the simulated decay material comprises a porous substance, and wherein the porous substance comprises pumice.

53. The method of claim 36, wherein the simulated decay material comprises coloring.

54. The method of claim 36, wherein the simulated decay material comprises food coloring.

55. The method of claim 36, wherein the simulated decay material is homogeneous.

56. The method of claim 36, further comprising curing the simulated decay material.

57. The method of claim 36, further comprising curing the simulated decay material with light.

58. The method of claim 36, further comprising curing the simulated decay material with visible light.

59. The method of claim 36, wherein the simulated decay material is detectable by caries detecting stain.

60. The method of claim 36, wherein the simulated decay material is radiolucent.

61. The method of claim 36, wherein the simulated decay material is radio-opaque.

62. The method of claim 36, wherein applying the simulated decay material comprises applying simulated decay material of uniform composition in layers.

63. The method of claim 36, wherein applying the simulated decay material comprises applying simulated decay material of varying composition in layers.

64. The method of claim 36, wherein applying the simulated decay material comprises applying simulated decay material of varying composition in layers, such that an inner layer of simulated decay material is of greater hardness than an outer layer of simulated decay material.

65. The method of claim 36, further comprising curing the simulated decay material.

66. The method of claim 36, further comprising curing the simulated decay material, wherein curing the simulated decay material comprises successively curing layers of simulated decay material.

67. The method of claim 36, further comprising curing the simulated decay material, wherein curing the simulated decay material comprises successively curing layers of simulated decay material of varying composition.
